(19) United States
(12) Patent Application Publication
(10) Pub. No.: US 2010/0023736 A1
(43) Pub. Date: Jan. 28, 2010

(54) RECONFIGURABLE CIRCUIT, RESET METHOD, AND CONFIGURATION INFORMATION GENERATION DEVICE

(76) Inventors: Takashi Morimoto, Osaka (JP); Shinichiro Nishioka, Osaka (JP); Koji Asai, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/520,909

(22) PCT Filed: Oct. 30, 2008
(86) PCT No.: PCT/JP2008/003121

§ 371 Date: Jun. 23, 2009

(30) Foreign Application Priority Data
Nov. 12, 2007 (JP) 2007-292829

(51) Int. Cl. G06F 9/00; G06F 9/30; G06F 9/45

(52) U.S. Cl. 712/227; 713/100; 717/143; 712/E09.016

(57) ABSTRACT

The present invention provides a reconfigurable circuit that comprises a plurality of reconfiguration cells and changes a configuration of a computation processing unit included in each of the reconfiguration cells. Here, each of the reconfiguration cells further includes: a computation storage unit operable to store a result of a computation performed by the computation processing unit; a flag holding unit operable to hold an initialization flag indicating whether an initialization of the computation storage unit is required; and an initialization control unit operable to, during the configuration change of the computation processing unit, control the initialization of the computation storage unit based on the initialization flag held by the flag holding unit.

### TECHNICAL FIELD

The present invention relates to a reconfigurable circuit, in particular to a technique to control initializing registers that hold computation results within the reconfigurable circuit.

### BACKGROUND ART

In Recent years, LSIs called SoCs (System on A Chip) have been extensively developed. A SoC integrates on one chip a system which conventionally is realized using mmultiple LSIs.

In a SoC, a variety of functions are integrated in one LSI. However, integrating all the necessary functions requires a larger circuit area. In addition, a certain combination of functions are specified to be utilized for a certain use case. Accordingly, any inactive blocks on the LSI leads to inefficiency of the mounting area. In view of these problems, reconfigurable circuits having hardware flexibility have been developed.

Reconfigurable circuits hold intermediate data, which is a computation result, in an internal register of each reconfiguration cell. However, because the registers are initialized during a configuration change, computation results obtained before a configuration change cannot be used again after the configuration change.

Patent Document 1 discloses an invention which provides a data cache unit outside the reconfiguration cell, and saves a computation result in the data cache unit so that the computation result can be used again after the configuration change.

Specifically, when processing an image in units of blocks, the invention disclosed by Patent Document 1 saves intermediate data of multiple blocks in the data cache unit, thereby achieving efficient image processing.

Patent Document 1: Japanese Patent Application Publication 2001-202236

### DISCLOSURE OF THE INVENTION

### Problems the Invention is Going to Solve

However, the technique according to Patent Document 1 requires the data cache unit for saving data, which results in an cost increase.

Furthermore, although the technique according to Patent Document 1 is considered to be effective when performing the same processing on multiple pieces of block data (e.g., image processing), if the technique is used for processing which repeatedly performs reconfiguration in a short period of time using a small amount of configuration cells, overhead due to data saving and data restoration increases, lowering the processing performance as a result.

The present invention was conceived in view of the above problems, and aims to provide, without providing a data cache unit, a reconfigurable circuit that enables intermediate data processed by a circuit to be used by a subsequent circuit, an initialization method for the reconfigurable circuit, and a configuration information generation apparatus for generating configuration information used by the reconfigurable circuit.

### Means of Solving the Problems

In order to achieve the above-stated aim, one embodiment of the present invention is a reconfigurable circuit that comprises a plurality of reconfiguration cells and changes a configuration of a computation processing unit included in each of the reconfiguration cells. Here, the each of the reconfiguration cells further includes: a computation storage unit operable to store a result of a computation performed by the computation processing unit; a flag holding unit operable to hold an initialization flag indicating whether an initialization of the computation storage unit is required; and an initialization control unit operable to, during the configuration change of the computation processing unit, control the initialization of the computation storage unit based on the initialization flag held by the flag holding unit.

### Effects of the Invention

With the stated structure, the computation result generated by a previous circuit can be used by a subsequent circuit without requiring a buffer memory for saving intermediate data, which is conventionally required.

Also, with the stated structure, for each of the reconfiguration cells included in the reconfigurable circuit, the computation storage unit can be selectively initialized in accordance with the computation to be performed, realizing efficient processing depending on use cases.

### BRIEF DESCRIPTION OF THE DRAWINGS

FIG. 1 shows a structure of a reconfigurable circuit 1;

FIG. 2 shows a functional structure of a reconfiguration cell 11;

FIG. 3 shows a functional structure of a configuration information storage unit 102;

FIG. 4 shows a functional structure of an initialization control unit 104;

FIG. 5 is a flowchart showing operations of the reconfiguration cell 11;

FIG. 6A is for explaining a specific example of processing by the reconfiguration cell 11; FIG. 6B shows a data structure of configuration information 120 input to the reconfiguration cell 11;

FIG. 7A schematically shows a structure of the reconfiguration cell 11; FIG. 7B is for explaining a specific example of an initialization control;

FIG. 8 is a flowchart showing an operation for generation processing of circuit configuration information;

FIG. 9 shows a GUI image for receiving setting of an initialization flag by a user in the generation processing of the circuit configuration information;

FIG. 10 shows a functional structure of are configuration cell 11a pertaining to a modification of the present invention;

FIG. 11 shows a functional structure of an initialization control unit 104a pertaining to the modification of the present invention;

FIG. 12 explains an initialization control pertaining to a modification of the present invention;

FIG. 13 explains an initialization control pertaining to a modification of the present invention;

FIG. 14 shows an exemplary case in which the reconfigurable circuit of the present invention is applied to a Blu-ray recorder system; and

FIG. 15 shows an application example of the reconfigurable circuit of the present invention.

### DESCRIPTION OF REFERENCE NUMERALS

1 reconfigurable circuit
10 configuration control unit
11 reconfiguration cell
11a reconfiguration cell
12 reconfiguration cell
101 computation processing unit
102 configuration information storage unit
103 wiring unit
104 initialization control unit
104a initialization control unit
105 computation storage unit
1021 computation configuration information holding unit
1022 wiring configuration information holding unit
1023 initialization flag holding unit
1041 initialization generation unit
1042 initialization protection unit

### BEST MODE FOR CARRYING OUT THE INVENTION

In an aspect recited in claim 1, a reconfigurable circuit comprises a plurality of reconfiguration cells and changes a configuration of a computation processing unit included in each of the reconfiguration cells, wherein the each of the reconfiguration cells further includes: a computation storage unit operable to store a result of a computation performed by the computation processing unit; a flag holding unit operable to hold an initialization flag indicating whether an initialization of the computation storage unit is required; and an initialization control unit operable to, during the configuration change of the computation processing unit, control the initialization of the computation storage unit based on the initialization flag held by the flag holding unit.

In a reconfigurable circuit that is an aspect recited in claim 2, the initialization control unit performs the initialization control such that (i) if the initialization flag indicates that the initialization is required, the computation storage unit is initialized, and (ii) if the initialization flag indicates that the initialization is not required, the computation storage unit is not initialized.

According to the stated structure, for each reconfiguration cell, an initialization flag indicating whether an initialization is required or not can be used to initialize the computation storage unit or to protect the computation storage unit from being initialized.

Here, when the initialization flag holding unit holds an initialization flag indicating that the initialization is not required, the computation result stored in the computation storage unit can be used by the subsequent circuit without being saved in an outside buffer.

In a reconfigurable circuit that is an aspect recited in claim 3, the each of the reconfiguration cells further includes: an acquisition unit operable to acquire (a) a piece of configuration information to be used for the configuration change of the computation processing unit and (b) the initialization flag in correspondence with each other; and a configuration information holding unit operable to hold the piece of configuration information acquired by the acquisition unit, the flag holding unit holds the initialization flag acquired by the acquisition unit, and the initialization control unit performs the initialization control on the computation storage unit based on the initialization flag during the configuration change of the computation processing unit performed in accordance with the piece of configuration information corresponding to the initialization flag.

Here, the acquisition unit is realized by a configuration information storage unit 102 in the following embodiment.

According to the stated structure, the initialization control unit performs the initialization control on the computation storage unit before computation processing is performed by the circuit which is to be configured based on the piece of configuration information acquired in correspondence with the initialization flag. Accordingly, when the initialization flag indicates that the initialization is not required, the computation processing unit can use the result of the computation performed by the previous circuit.

In a reconfigurable circuit that is an aspect recited in claim 4, the acquisition unit, after acquiring the piece of configuration information and the initialization flag, acquires an other piece of configuration information to be used for a further configuration change of the computation processing unit, and the initialization control unit performs the initialization control on the computation storage unit based on the initialization flag during the configuration change of the computation processing unit performed in accordance with the other piece of configuration information acquired by the acquisition unit.

According to the stated structure, while the result of the computation performed by the circuit configured based on the piece of configuration information acquired in correspondence with the initialization flag being stored in the computation storage unit, the initialization control unit performs the initialization control based on the initialization flag while the computation processing unit is reconfigured based on the subsequent piece of configuration information. Consequently, if the initialization flag indicates that the initialization is not required, the computation processing unit can use, in the circuit to be configured based on the subsequent piece of configuration information, the computation result obtained by the circuit configured based on the piece of configuration information.

In a reconfigurable circuit that is an aspect recited in claim 5, the each of the reconfiguration cells is in a mode that is one of a protection mode and a normal mode, the protection mode protecting the computation storage unit from being initialized, and the normal mode allowing the computation storage unit to be initialized, the initialization flag includes (i) a protection setting flag for shifting the mode of the reconfiguration cell from the normal mode to the protection mode and (ii) a protection cancellation flag for shifting the mode of the reconfiguration cell from the protection mode to the normal mode, the initialization control unit performs the initialization control such that (i) one of (a) if the reconfiguration cell is in the normal mode and (b) if the reconfiguration cell is in the protection mode and the initialization flag is set to the protection cancellation flag, the computation storage unit is initialized during the configuration change of the computation processing unit performed in accordance with the piece of configuration information, and (ii) if the reconfiguration cell is in the protection mode and the initialization flag is not set to the protection cancellation flag, the computation storage unit is not initialized during the configuration change of the computation processing unit performed in accordance with the piece of configuration information.

According to the stated structure, each reconfiguration cell shifts the mode based on the initialization flag, and determines whether or not to protect the computation storage unit from being initialized based on the mode. This way, even in a case where a circuit is configured based on a piece of configuration information that does not include a protection setting flag, the computation storage unit can be protected from being initialized as long as the mode is the protection mode.

In a reconfigurable circuit that is an aspect recited in claim 6, the configuration information holding unit outputs the piece of configuration information to the computation processing unit upon detecting a configuration change signal which is an instruction to perform the configuration change of the computation processing unit, the computation processing unit performs an internal reconfiguration using the piece of configuration information received from the configuration information holding unit, and the initialization control unit, upon detecting the configuration change signal, performs the initialization control on the computation storage unit in parallel with the internal reconfiguration performed by the computation processing unit.

For example, in a case where an initialization signal is input to each reconfiguration cell with use of global wiring for the clock, one clock is required for the configuration switch signal and the initialization signal, respectively, during the configuration change. Assuming that an application which performs processing while changing the configuration in several clocks is executed in this case, one clock required for the configuration switch signal and one clock required for the initialization signal cause the time required for an initialization to become too much as overhead processing.

However, according to the above-stated structure, because the reconfiguration processing and the initialization control are processed in parallel with each other, the time required for the initialization can be kept within the time required for the reconfiguration, resolving the overhead due to the initialization control as a result.

In a reconfigurable circuit that is an aspect recited in claim 7, the initialization control unit includes: an initialization generation unit operable to generate an initialization signal upon detecting the configuration change signal; and an initialization protection unit operable to, upon receiving the initialization signal generated by the initialization generation unit, judge, based on the initialization flag held by the flag holding unit, whether or not to output the initialization signal to the computation storage unit, and (i) only when the judgement is affirmative, output the initialization signal to the computation storage unit, and (ii) when the judgement is negative, not output the initialization signal to the computation storage unit, and the computation storage unit performs an internal initialization only upon receiving the initialization signal from the initialization protection unit.

According to the stated structure, the initialization control is performed for each reconfiguration cell using local wiring. Accordingly, the global wiring for inputting the initialization signal to the reconfiguration cell from outside is not required.

In an aspect recited in claim 8, a configuration information generation apparatus is for generating configuration information used by a reconfigurable circuit that includes a plurality of reconfiguration cells and changes a configuration of a computation processing unit included in each of the reconfiguration cells further including a computation storage unit operable to store a result of a computation performed by the computation processing unit, the configuration information generation apparatus receiving from a user, in a process of generating the configuration information, a selection of whether or not the computation storage unit is to be initialized during the configuration change of the reconfiguration cell.

Here, the configuration information generation apparatus is realized by a compile apparatus executing a compiler in the embodiment described later.

According to the stated structure, a user can specify whether the initialization is required or not for each reconfiguration cell when creating various programs to be executed using the reconfigurable circuit.

A configuration information generation apparatus that is an aspect recited in claim 9 comprises: a source code input unit operable to receive input of a source code computation configuration information which is information to be used for the configuration change of the computation processing unit; an analysis unit operable to analyze a syntax of the source code; an output unit operable to output, when the analysis unit detects a predetermined syntax indicating the computation storage unit, a GUI image for receiving, from a user, setting of an initialization flag which indicates whether the computation storage unit is to be initialized or not during the configuration change; and a user input unit operable to receive the setting of the initialization flag by a user operation.

According to the stated structure, by using a GUI image, the user can set the initialization flag without complex operations.

A configuration information generation apparatus that is an aspect recited in claim 10 further comprises a configuration information generation unit operable to generate the configuration information including the computation configuration information and the initialization flag set by the user.

According to the stated structure, the configuration information generation apparatus can generate configuration information including the initialization flag specified by the user.

In the following, a reconfigurable circuit 1 which is an embodiment of the present invention is described with reference to the drawings.

### <Structure>

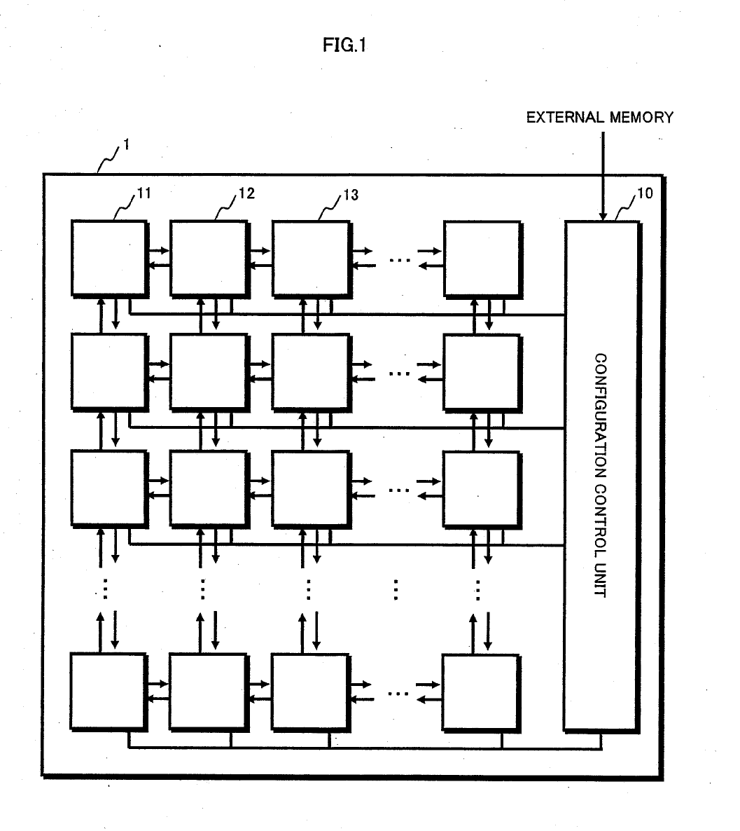

FIG. 1 shows the reconfigurable circuit 1.

As shown in the figure, the reconfigurable circuit 1 includes a configuration control unit 10 and a plurality of reconfiguration cells 11, 12, 13, . . . arranged in a matrix.

### 1. Configuration Control Unit 10

The configuration control unit receives circuit configuration information from an external memory that is externally connected the reconfigurable circuit 1. The circuit configuration information includes pieces of configuration information for determining a computation to be performed by and wiring of each reconfiguration cell in order to configure a desired circuit using the reconfiguration cells 11, 12, 13, . . . .

The configuration control unit 10 is connected to all of the reconfiguration cells included in the reconfigurable circuit 1, and outputs to each reconfiguration cell a corresponding piece of configuration information. Also, the configuration control unit 10 outputs to each reconfiguration cell a configuration switch signal which is an instruction to change a circuit.

### 2. Reconfiguration Cell

Each of the plurality of reconfiguration cells shown in FIG. 1 includes combination circuits, sequential circuits, flip-flops and the like, and performs different computations in accordance with received pieces of configuration information to conduct processing.

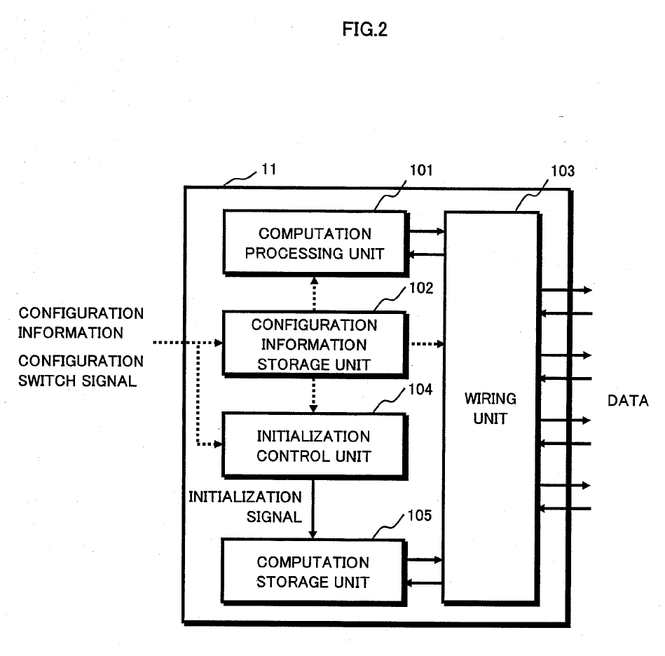

FIG. 2 is a functional block diagram showing the structure of the reconfiguration cell 11 in terms of function.

It should be noted that the reconfiguration cells 12, 13, . . . other than the reconfiguration cell 11 each are equal to the reconfiguration cell 11 in structure, and accordingly, description is omitted here.

As shown in FIG. 2, the reconfiguration cell 11 includes a computation processing unit 101, a configuration information storage unit 102, a wiring unit 103, an initialization control unit 104, and a computation storage unit 105. In the following, description is provided on each structural component of the reconfiguration cell 11.

(1) Computation Processing Unit 101

The computation processing unit 101 includes such as ALU (Arithmetic Logic Unit) and LUT (Look Up Table), and performs an arithmetic operation and a logic operation using computation configuration information received from the configuration information storage unit 102, a computation result stored in the computation storage unit 105, computation results received from other reconfiguration cells and the like.

The computation processing unit 101 receives computation configuration information from the configuration information storage unit 102, using a configuration switch signal as a trigger, and reconfigures a circuit by changing a set value of LUT in accordance with the received computation configuration information.

It should be noted that the computation processing unit 101 is, specifically, constituted of a small-scale SRAM.

(2) Configuration Information Storage Unit 102

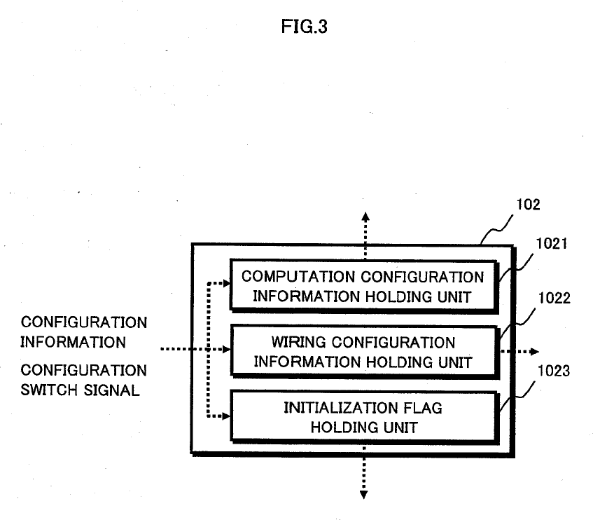

FIG. 3 shows the inner structure of the configuration information storage unit 102.

As shown in the figure, the configuration information storage unit 102 includes a computation configuration information holding unit 1021, a wiring configuration information holding unit 1022, and an initialization flag holding unit 1023, and each of these structural components is constituted of a register composed of a plurality of flip-flops.

The configuration information storage unit 102 receives configuration information from the configuration control unit 10, thereby obtaining the configuration information. The configuration information is information for realizing a desired computation by the computation processing unit 101, and includes computation configuration information, wiring configuration information, and an initialization flag.

The configuration information storage unit 102 stores, out of the configuration information received from the configuration control unit 10, (a) the computation configuration information in the computation configuration information holding unit 1021, (b) the wiring configuration information in the wiring configuration information holding unit 1022, and (c) the initialization flag in the initialization flag holding unit 1023.

The following explains each kind of information included in the configuration information.

The computation configuration information is information for determining a computation to be performed by the computation processing unit 101, and, as described above, includes such as a set value of LUT.

The wiring configuration information is information for determining connection of the wiring unit 103, and specifically, is information indicating ON/OFF of a plurality of transistor switches included in the wiring unit 103.

The initialization flag is information for controlling an initialization of the computation storage unit 105, and specifically, includes two types, which are a protection setting flag and a protection cancellation flag.

The initialization protection unit 1042 (described later) is either in a protection mode or in a normal mode, the protection mode protecting the computation storage unit 105 from being initialized, and the normal mode not protecting the computation storage unit 105 from being initialized. The protection setting flag is a flag for shifting the status of the initialization protection unit 1042 from the normal mode to the protection mode; and the protection cancellation flag is a flag for shifting the status of the initialization protection unit 1042 from the protection mode to the normal mode.

When the status of the initialization protection unit 1042 is the protection mode, data in the computation storage unit 105 is protected from the initialization during the circuit reconfiguration. Accordingly, the computation processing unit 101 can use the computation result generated by a previous computation in a computation immediately following the previous computation.

On the other hand, when the status of the initialization protection unit 1042 is the normal mode, data in the computation storage unit 105 is initialized while the circuit is reconfigured. Accordingly, the computation processing unit 101 cannot use the computation result generated by the previous computation in the subsequent computation.

The reconfiguration cell 11 performs a series of processing while changing configurations of the circuit based on the received pieces of configuration information. During the series of processing, the reconfiguration cell 11 performs an initialization control of the computation storage unit 105 while changing the status (mode) of the initialization protection unit 1042 based on the initialization flag included in the pieces of configuration information. Consequently, the reconfiguration cell 11 can effectively use computation results stored in the computation storage unit 105 during the series of processing, thereby improving the processing efficiency.

It should be noted that in a case where the piece of configuration information received from the configuration control unit 10 by the configuration information storage unit 102 includes only computation configuration information and wiring configuration information and does not include any of the protection setting flag and the protection cancellation flag, the initialization protection unit 1042 performs the following processing. The initialization protection unit 1042 maintains the current status and controls the initialization of the computation storage unit 105 in accordance with the maintained current status.

Here, as a specific example at the implementation level, the initialization flag included in the configuration information can be represented with 2-bit data. In this case, for example, the protection setting flag may be “01”, the protection cancellation flag may be “10”, and an initialization flag other than the protection setting flag and the protection cancellation flag may be “00”.

(3) Wiring Unit 103

The wiring unit 103 can connect the computation processing unit 101 and the computation storage unit 105 with other reconfiguration cells. Specifically, the wiring unit 103 is a terminal of wiring connecting each reconfiguration cell, and is composed of a plurality of transistor switches. Each transistor switch is set to “ON” or “OFF” in accordance with the wiring configuration information received from the configuration information storage unit 102.

Also, the wiring unit 103, upon receiving the wiring configuration information from the configuration information storage unit 102, using the configuration switch signal as a trigger, changes the ON/OFF setting of each transistor switch in accordance with the received wiring configuration information, thereby being able to change connection destinations.

(4) Initialization Control Unit 104

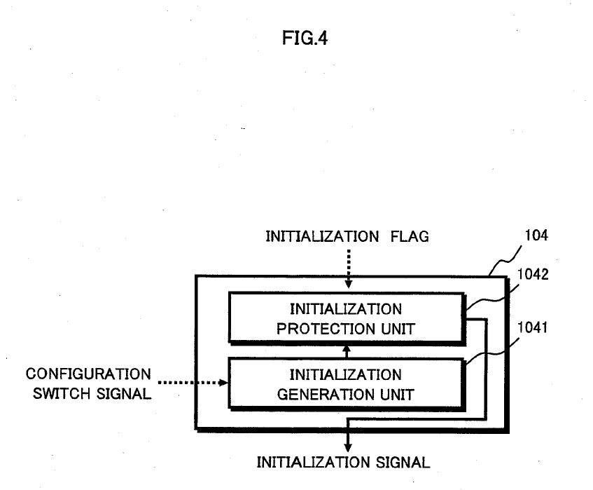

FIG. 4 shows the inner structure of the initialization control unit 104. As shown in the figure, the initialization control unit 104 includes an initialization generation unit 1041 and an initialization protection unit 1042.

The initialization generation unit 1041 is configured to detect a reconfiguration of the circuit, and upon detecting the reconfiguration, generates an initialization signal. The initialization generation unit 1041 outputs the generated initialization signal to the initialization protection unit 1042.

It should be noted that in the present embodiment, a configuration switch signal, which is an instruction to reconfigure the circuit, is input to each reconfiguration cell from the configuration control unit 10, and the initialization generation unit 1041 generates the initialization signal upon detecting the configuration switch signal.

The initialization protection unit 1042 holds a status of either the normal mode or the protection mode.

Upon receiving the initialization signal generated by the initialization generation unit 1041, the initialization protection unit 1042 in the normal mode outputs the initialization signal to the computation storage unit 105.

The initialization protection unit 1042 is configured to mask an initialization signal when in the protection mode, and, by masking the initialization signal, is able to protect the computation storage unit 105 from being initialized.

In an initial state before the reconfiguration cell 11 performs any processing, the initialization protection unit 1042 is in the normal mode. After the reconfiguration cell 11 has performed processing based on the configuration information including a protection setting flag, the initialization protection unit 1042 shifts from the normal mode to the protection mode. After that, the initialization protection unit 1042 maintains the protection mode until the reconfiguration cell 11 reconfigures the circuit based on the configuration information including a protection cancellation flag.

(5) Computation Storage Unit 105 The computation storage unit 105 includes a register for holding a result of a computation performed by the computation processing unit 101.

The computation storage unit 105 initializes the register upon receiving the initialization signal from the initialization protection unit 1042.

As described earlier, in the case where the register of the computation storage unit 105 gets initialized while the circuit is reconfigured, the computation result generated from the computation performed by a previously-configured circuit can be used in a subsequently-configured circuit. On the other hand, if the register does not get initialized while the circuit is reconfigured, the computation result generated from the computation by the previously-configured circuit cannot be used in the subsequently-configured circuit.

### <Operations>

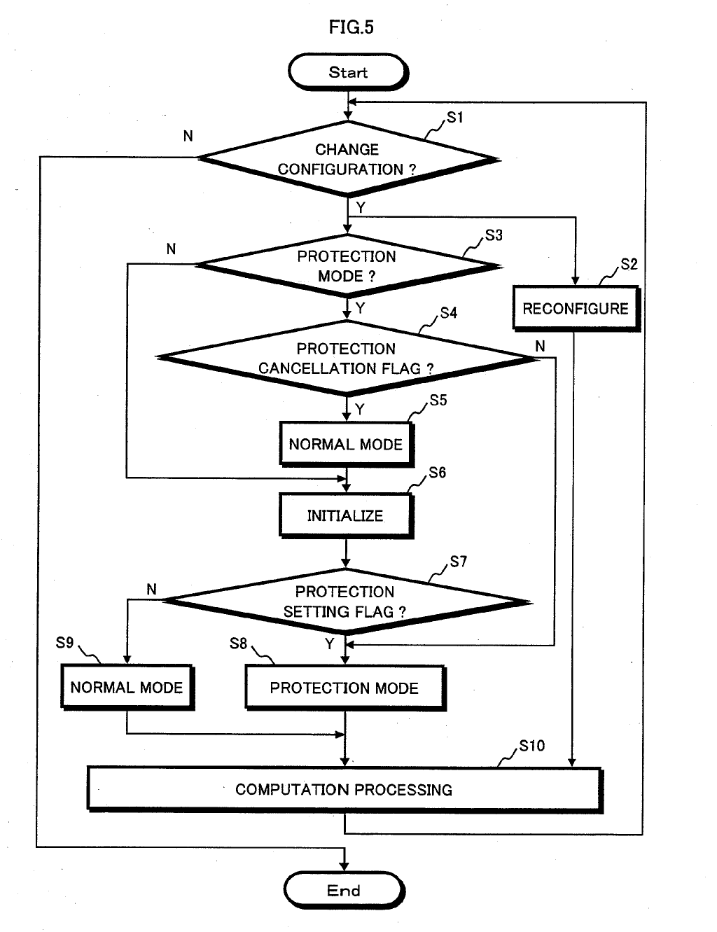

FIG. 5 shows a flowchart showing operations of the reconfiguration cell 11.

Since the reconfigurable circuit 1 is constituted of a plurality of reconfiguration cells, the operations shown in FIG. 5 are processed in parallel by the respective reconfiguration cells included in the reconfigurable circuit 1.

The reconfiguration cell 11 starts processing upon the configuration information storage unit 102 receiving a piece of configuration information.

When a configuration switch signal is not detected (N at step S1, the reconfiguration cell 11 terminates processing. When a configuration switch signal is detected (Y at the step S1), the reconfiguration cell 11 performs processing of step S2 and processing from step S3 to step S9 in parallel with each other.

Having detected the configuration switch signal in the step S1, the configuration information storage unit 102 outputs the computation configuration information held by the computation configuration information holding unit 1021 to the computation processing unit 101, and outputs the wiring configuration information held by the wiring configuration information holding unit 1022 to the wiring unit 103.

The computation processing unit 101 reconfigures the circuit based on the received computation configuration information, and the wiring unit 103 performs setting of ON/OFF of transistor switches based on the received wiring configuration information (step S2).

Having detected the configuration switch signal in the step S1, the initialization generation unit 1041 generates an initialization signal and outputs the initialization signal to the initialization protection unit 1042.

Upon receiving the initialization signal, the initialization protection unit 1042 judges whether the current mode is the protection mode or the normal mode.

In the case of the normal mode (N at the step S3), the processing proceeds to step S6.

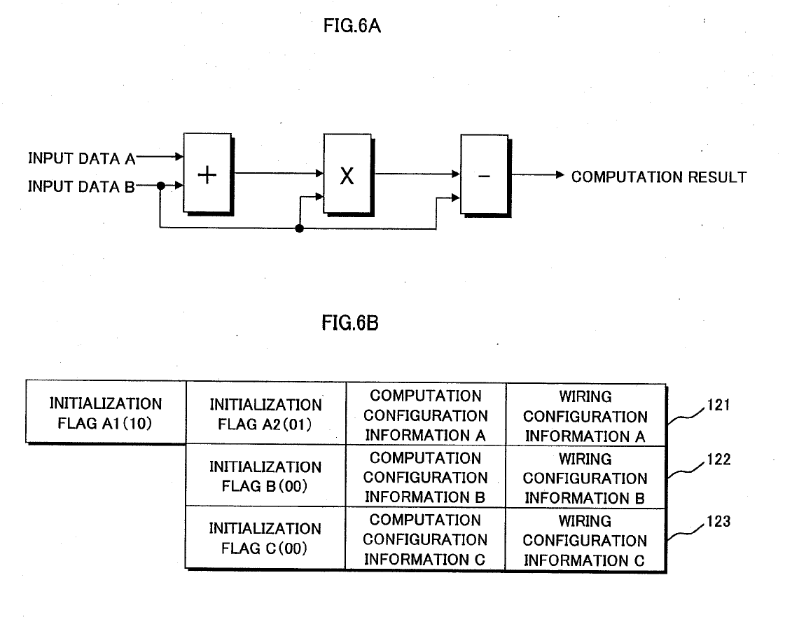

In the case of the protection mode (Y at the step S3), the initialization protection unit 1042 judges whether a protection cancellation flag is held by the initialization flag holding unit 1023. It should be noted that here, when two types of initialization flags are held by the initialization flag holding unit 1023 (when two types of initialization flags A1 and A2 are included, as shown by configuration information A in FIG. 6B described later), the initialization protection unit 1042 judges whether the first initialization flag (the initialization flag A1 in FIG. 6B) is a protection cancellation flag or not.

When a protection cancellation flag is held (Y at step S4), the initialization protection unit 1042 changes the mode from the protection mode to the normal mode (step S5), and proceeds to the step S6.

When a protection cancellation flag is not held (N at the step S4), the initialization protection unit 1042 proceeds to step S8.

When the initialization protection unit 1042 is in the normal mode, the initialization protection unit 1042 outputs the initialization signal to the computation storage unit 105. Having received the initialization signal, the computation storage unit 105 initializes the internal register (step S6).

Next, the initialization protection unit 1042 judges whether or not a protection setting flag is held by the initialization flag holding unit 1023. It should be noted that in the case where the two types of initialization flags are held by the initialization flag holding unit 1023 (when two types of initialization flags A1 and A2 are included, as shown by the configuration information A in FIG. 6B described later), the initialization protection unit 1042 judges whether the initialization flag subsequent to the first initialization flag (the initialization flag A2 in FIG. 6B) is a protection setting flag or not.

When a protection setting flag is held (Y at step S7), the initialization protection unit 1042 changes the mode to the protection mode, and if the mode is already the protection mode, maintains the protection mode (step S8).

When a protection setting flag is not held (N at the step S7), the initialization protection unit 1042 changes the mode to the normal mode, and if the mode is already the normal mode, maintains the normal mode (step S9).

Upon completing the reconfiguration in the step S2 and the initialization control from the step S3 to the step S9, the computation processing unit 101 performs computation processing (step S10).

After that, the reconfiguration cell 11 returns to the step S1 and continues processing.

### <Specific Example>

Here, as shown in FIG. 6A, description is given on the case where the reconfiguration cell 11 performs processing, with respect to input data A and input data B, in the order of addition, multiplication, and subtraction in three clocks while changing the configuration each clock.

Here, the multiplication at the second clock and the subtraction at the third clock each are performed using the computation results of the respective previous processing.

It should be noted that hereinafter, the circuits for performing the addition, multiplication, and subtraction shown in FIG. 6A are called a circuit A, circuit B, and circuit C, respectively.

In order to perform a series of processing shown in FIG. 6A, pieces of configuration information which are configuration information A (121), configuration information B (122), and configuration information C (123) are input to the configuration information storage unit 102.

The configuration information A is information for configuring the circuit A, the configuration information B is information for configuring the circuit B, and the configuration information C is information for configuring the circuit C.

The configuration information A (121) includes an initialization flag A1 (10), an initialization flag A2 (01), computation configuration information A, and wiring configuration information A. The initialization flags A1 and A2 are information for controlling an initialization of the computation storage unit 105 while the circuit A is configured.

The configuration information B (122) includes an initialization flag B (00), computation configuration information B, and wiring configuration information B. The initialization flag B is information for controlling an initialization of the computation storage unit 105 while the circuit B is configured.

The configuration information C (123) includes an initialization flag C (00), computation configuration information C, and wiring configuration information C. The initialization flag C is information for controlling an initialization of the computation storage unit 105 while the circuit C is configured.

It should be noted that here, the protection setting flag is denoted by “01”, and the protection cancellation flag is denoted by “10”. An initialization flag indicating neither the protection setting flag nor the protection cancellation flag is denoted by “00”. Accordingly, the initialization flag A1 is a protection cancellation flag, the initialization flag A2 is a protection setting flag, and the initialization flags B and C are neither of these.

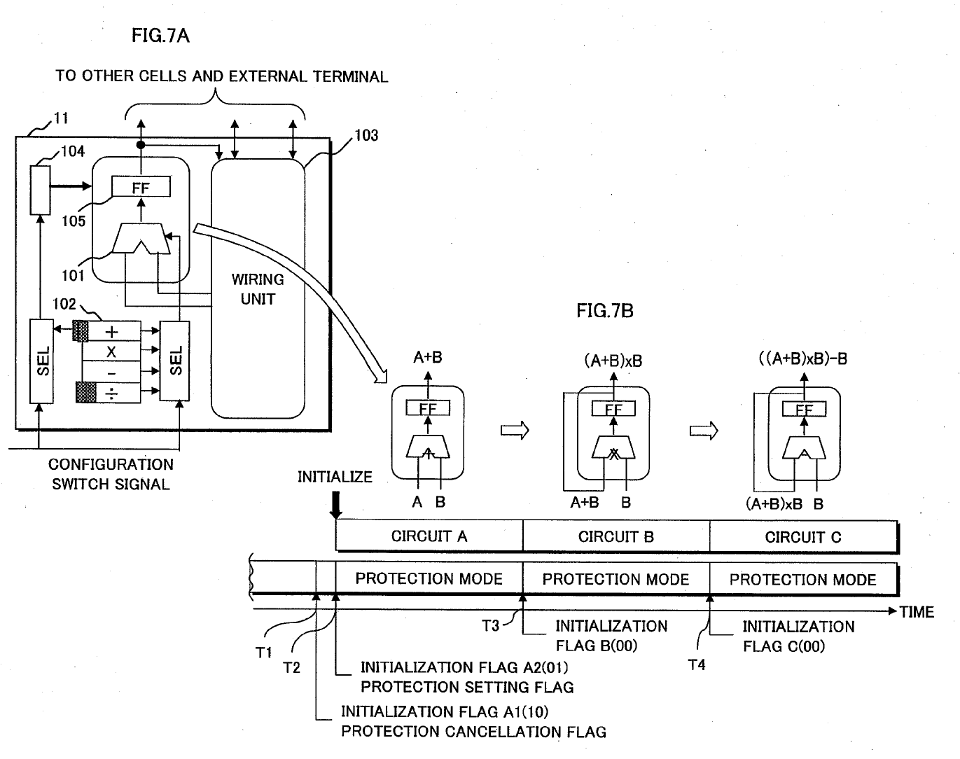

Next, the modes, initialization flags, and initialization control of the reconfiguration cell 11 are explained using FIG. 7.

FIG. 7A schematically shows structural components of the reconfiguration cell 11.

FIG. 7B is a diagram for explaining temporal changes of circuits configured in the reconfiguration cell 11 and the modes, the initialization flags, and initialization control.

First, upon detecting a configuration switch signal, the reconfiguration cell 11 starts processing based on the configuration information A (121).

As shown in FIG. 6B, the initialization flag A1 included in the configuration information A (121) is a protection cancellation flag. Accordingly, the reconfiguration cell 11 is set to the normal mode at a time T1 which precedes the series of processing composed of “addition->multiplication->subtraction”. The reconfiguration cell 11 maintains the normal mode until a protection setting flag appears.

The reconfiguration cell 11 is set to the normal mode at the time t1 to initialize the computation storage unit 105 prior to a computation by the circuit A.

It should be noted that if the mode prior to the start of the series of processing is the normal mode, the computation storage unit 105 is initialized as a matter of course without a protection cancellation flag while the circuit A is configured (see the step S3 and step S5 of the flowchart of FIG. 5). Thus, the initialization flag A1 here (protection cancellation flag) is for enabling the processing to be started upon an initialization of the computation storage unit 105 even in a case where the mode prior to the start of the series of processing is the protection mode.

Currently, the reconfiguration cell 11 is in the normal mode, and accordingly, the computation storage unit 105 is initialized after the time T1.

Subsequently, since the initialization flag A2, which is a protection setting flag, is included in the configuration information A (121), the reconfiguration cell 11 is set to the protection mode at a time T2 after the computation storage unit 105 is initialized (see steps S7 and S8 in the flowchart of FIG. 5). From here on, The reconfiguration cell 11 is kept at the protection mode until a protection cancellation flag appears.

In parallel with the initialization control, the computation processing unit 101 and the wiring unit 103 configure the circuit A based on the computation configuration information A and the wiring configuration information A included in the configuration information A (121), respectively. After that, the reconfiguration cell 11 performs the addition by means of the circuit A after the time T2. The resultant value A+B of the addition is stored into the computation storage unit 105.

Next, upon detecting a configuration switch signal, the reconfiguration cell 11 starts processing based on the configuration information B (122).

As shown in FIG. 6B, the initialization flag B included in the configuration information B (122) is not a protection cancellation flag, and accordingly, the reconfiguration cell 11 maintains the protection mode. Thus, the computation storage unit 105 is not initialized at a time T3.

In parallel with the initialization control, the computation processing unit 101 and the wiring unit 103 configure the circuit B based on the computation configuration information B and the wiring configuration information B included in the configuration information B (122), respectively. After that, the reconfiguration cell 11 performs multiplication by means of the circuit B after the time T3 using the value A+B stored in the computation storage unit 105. The resultant value (A+B)×B of the multiplication is stored into the computation storage unit 105.

Next, upon detecting a configuration switch signal, the reconfiguration cell 11 starts processing based on the configuration information C (123). in FIG. 6B, the initialization flag C included in the configuration information C (123) is not a protection cancellation flag, and accordingly, the reconfiguration cell 11 maintains the protection mode. Thus, the computation storage unit 105 is not initialized at a time T4.

In parallel with the initialization control, the computation processing unit 101 and the wiring unit 103 configure the circuit C based on the computation configuration information C and the wiring configuration information C included in the configuration information C (123), respectively. After that, the reconfiguration cell 11 performs subtraction by means of the circuit C after the time T4 using the value (A+B)×B stored in the computation storage unit 105. The resultant value ((A+B)×B)−B of the subtraction is stored into the computation storage unit 105, and subsequently, output to another reconfiguration cell or an external terminal.

### <Generation of Circuit Configuration Information>

In the process of creating configuration information used in the reconfigurable circuit 1, users can set the initialization flags included in the configuration information using EDA (Electronic Design Automation) tool. In the following, setting of the initialization flags with use of the EDA tool is explained.

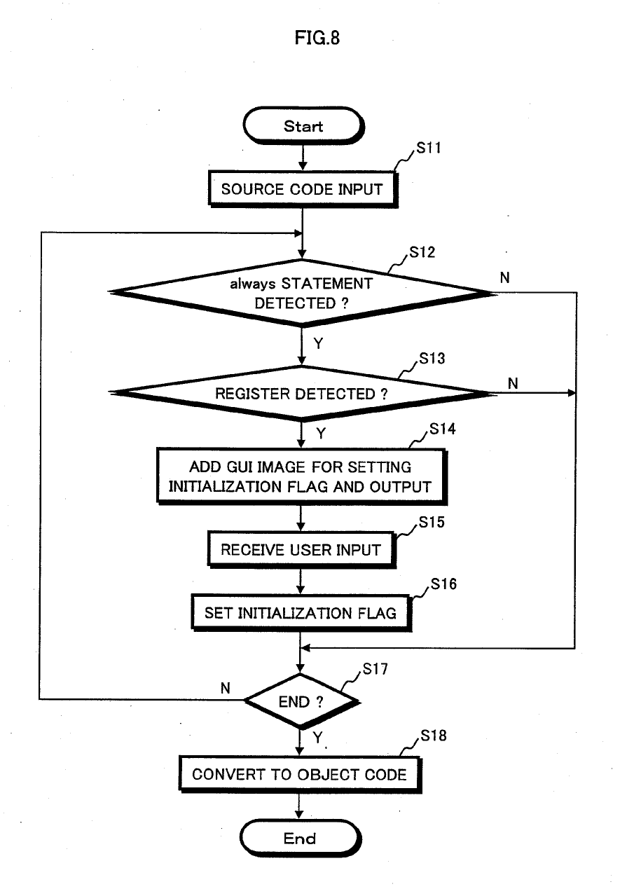

FIG. 8 is a flowchart showing the operations of generation processing of the circuit configuration information used in the reconfigurable circuit 1. The operations shown here are realized by execution of a compiler by a compiling apparatus (not depicted).

First, a source code is input (step S11) to the compiling apparatus. The source code input here is described using HDL (Hardware Description Language), and the description includes computation configuration information and wiring configuration information used in the reconfiguration cells of the reconfigurable circuit 1.

The compiling apparatus searches for an “always” statement. If no “always” statement is detected (N at step S12), the processing proceeds to step S17.

If an “always” statement is detected (Y at the step S12) the compiling apparatus searches each line following the “always” statement for a register description (here, Reg_delay_sel, as an example). If no register description is detected (N at the step S13), the processing proceeds to the step S17.

If a register description is detected (Y at the step S13), the compiling apparatus outputs, to a display connected to the compiling apparatus, a screen in which a GUI image for setting an initialization flag is added to the source code (step S14).

Following that, the compiling apparatus receives user input (step S15). For example, a user may input a selection of the protection setting flag and the protection cancellation flag using input devices such as a keyboard and a mouse connected to the compiling apparatus while watching the screen displayed on the display.

The compiling apparatus sets the initialization flag in correspondence with the computation configuration information and the wiring configuration information in accordance with the input received in the step S15 (step S16).

It should be noted that if multiple register descriptions are detected in the step S13, the compiling apparatus repeats the processing from the step S14 to the step S16 for each of the detected register descriptions.

If the compiling apparatus has not finished processing with respect to all of the input source codes (N at step S17), the process returns to the step S12 and continues the processing. If the compiling apparatus has finished the processing with respect to all of the input source codes (Y at the step S17), the compiling apparatus converts the source codes to object codes (step S18), and after that, terminates the processing.

The object codes generated here are stored into the external memory connected to the reconfigurable circuit 1, as circuit configuration information.

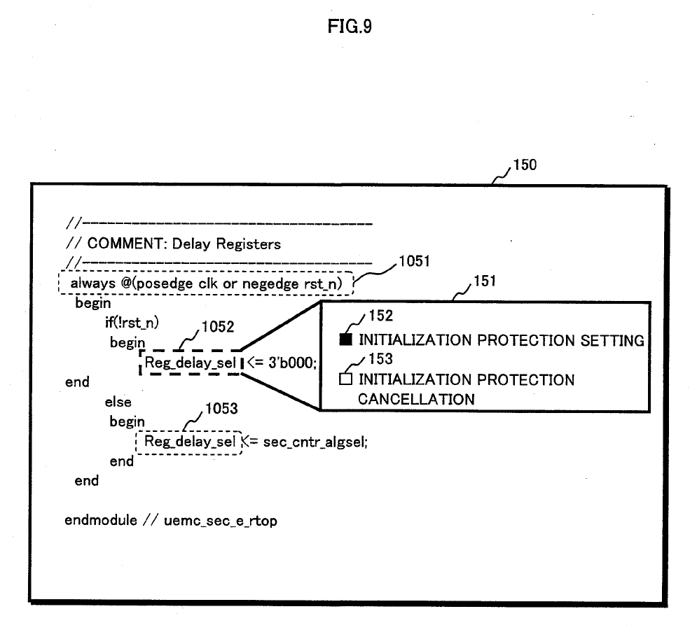

FIG. 9 shows a specific example of the screen displayed on the display in the step S15 of FIG. 15.

As shown in the figure, a screen 150 shows source codes of the configuration information described with HDL, and a GUI image 151 is added in correspondence with the register description (Reg_delay_sel) following an “always” statement 1051.

The GUI image 151 includes a checkbox 152 for receiving initialization protection setting and a checkbox 153 for receiving initialization cancellation setting. The user can put a check in the checkboxes 152 and 153 on the screen 150 using the input devices (for example, by clicking the mouse).

If the user puts a check in the checkbox 152, the compiling apparatus sets the initialization flag included in the configuration information to “protection setting flag” in order to protect the computation storage unit corresponding to the register description 1052 from being initialized.

On the other hand, if the user puts a check in the checkbox 153, the compiling apparatus sets the initialization flag included in the configuration information to “protection cancellation flag” in order to initialize the computation storage unit corresponding to the register description 1052.

### <Modifications>

Although the present invention has been described based on the above embodiment, the present invention is not limited to this embodiment. The following modifications are also included in the present invention.

(1) According to the above-described embodiment, initialization flags correspond one-to-one to the computation storage units of the reconfiguration cells, enabling a separate initialization control for each of the reconfiguration cells. However, the present invention is not limited to this structure, and an initialization flag can be assigned to a specific bit field in the computation storage unit to control the initialization for each bit field. With this structure, a detailed initialization control can be realized.

(2) According to the above-described embodiment, the initialization control unit 104 includes the initialization generation unit 1041 which generates an initialization signal upon detecting a configuration switch signal. However, the present invention is not limited to this structure, and includes a case such as below.

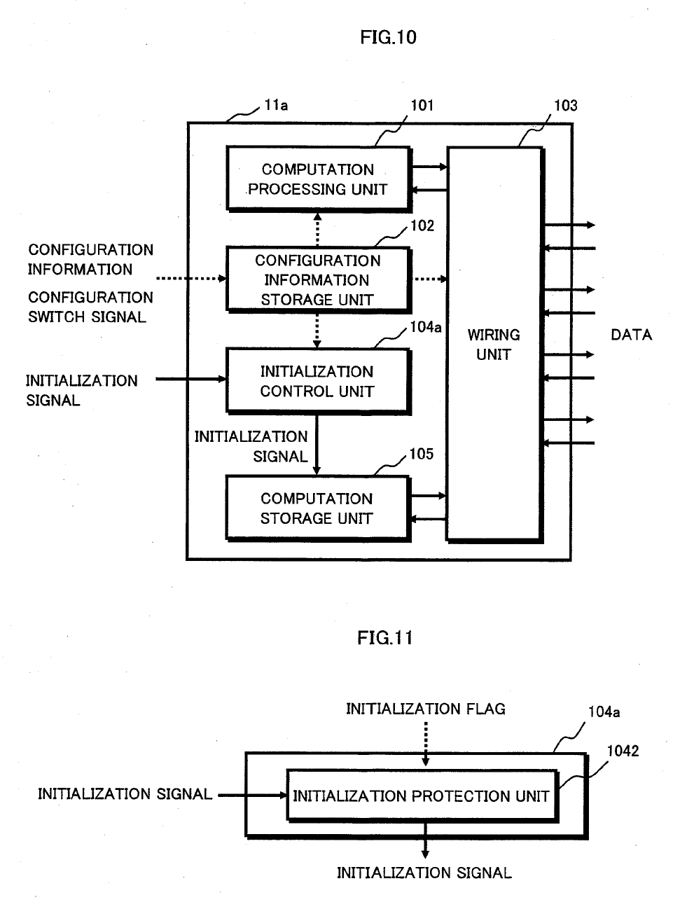

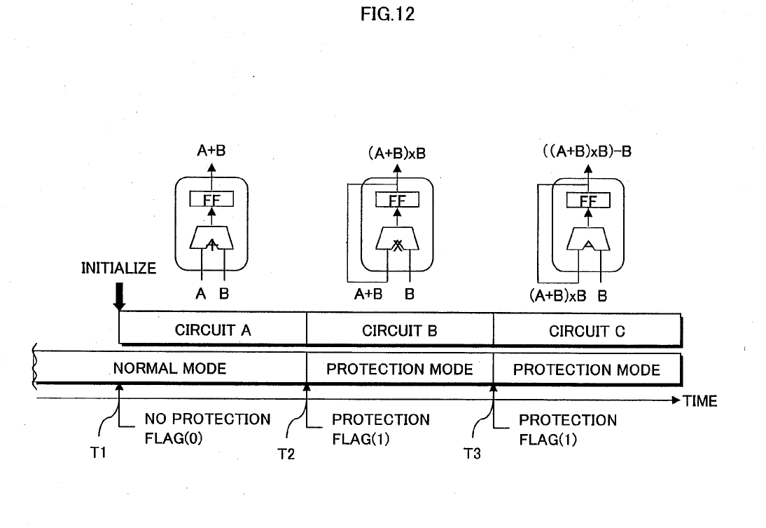

For example, a reconfiguration cell 11a shown in FIG. 10 includes an initialization control unit 104a instead of the initialization control unit 104 of the above-described embodiment. The initialization control unit 104a receives an initialization signal as an external signal, instead of generating an initialization signal. While this case requires more wiring resources, the initialization control unit 104a includes only the initialization protection unit 1042, and does not need to include the initialization generation unit 1041, as shown in FIG. 11.

(3) According to the above-described embodiment, the initialization flag is a piece of 2-bit information, and includes two kinds, which are the protection setting flag and the protection cancellation flag. However, the initialization flag according to the present invention can be realized with a piece of 1-bit information, using only the protection flag and not using the protection cancellation flag.

For example, an initialization control can be performed under the assumption that “the protection flag is present” when the initialization flag included in the configuration information is “1”, and “the protection flag is absent” when the initialization flag included in the configuration information is “0”.

Also, according to the above-described embodiment, an expiry time of the protection setting flag (expiry time of the protection mode) is when a protection cancellation flag appears next. However, when realizing the initialization control using only the protection flag, the expiry time of the protection flag (expiry time of the protection mode) is when the reconfiguration cell has performed processing using one configuration.

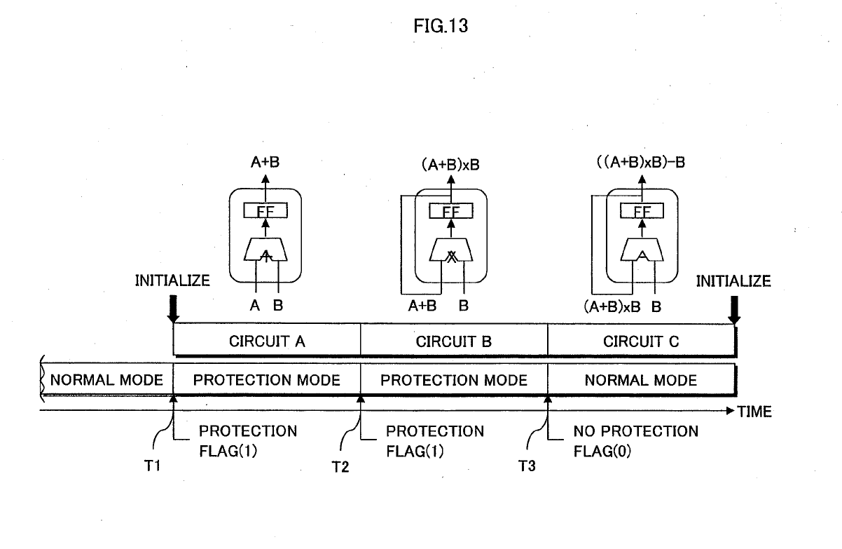

FIGS. 12 and 13 each show an embodiment that realizes the initialization control using only the protection flag. Here, description is provided using the same example which has been described with reference to FIGS. 6 and 7. It should be noted that the mode of the initialization protection unit prior to configuring the circuit A in the reconfiguration cell is assumed to be “normal mode”.

According to the specific example of FIG. 12, when a protection flag is included in the configuration information, the computation storage unit is protected from being initialized during the configuration change of the circuit based on the configuration information.

In this case, the value of the initialization flag A included in the configuration information A is set to “0”, the value of the initialization flag B included in the configuration information B is set to “1”, and the value of the initialization flag C included in the configuration information C is set to “1”.

Since the initialization flag A is “0”, the initialization protection unit is in the normal mode from a time T1 to a time T2, and the computation storage unit 105 is initialized at the time T1 which precedes the processing using the circuit A.

Since the initialization flag B is “1”, the initialization protection unit is in the protection mode from the time T2 to a time T3, and the computation storage unit 105 is protected from being initialized at the time T2.

Since the initialization flag C is “1”, the initialization protection unit is in the protection mode from the time T3 onward, and the computation storage unit is protected from being initialized at the time T3.

With this structure, the computation processing unit 101 is able to use, in the circuit B, the computation result obtained by the circuit A, and similarly, use, in the circuit C, the computation result obtained by the circuit B.

According to the specific example of FIG. 13, when the protection flag is included in the configuration information, the computation storage unit is protected from being initialized during the configuration change of the circuit based on the next piece of configuration information.

In this case, the value of the initialization flag A included in the configuration information A is set to “1”, the value of the initialization flag B included in the configuration information B is set to “1”, and the value of the initialization flag C included in the configuration information C is set to “0”.

Since the initialization protection unit is in the normal mode prior to the time T1, the computation storage unit is initialized at the time T1.

Also, since the initialization flag A is “1”, the initialization protection unit is in the protection mode from the time T1 to the time T2, and the computation storage unit is protected from being initialized at the time T2.

Since the initialization flag B is “1”, the initialization protection unit is in the protection mode from the time T2 to the time T3, and the computation storage unit 105 is protected from being initialized at the time T3.

Since the initialization flag C is “0”, the initialization protection unit is in the protection mode from the Time T3 onward, and the computation storage unit is initialized during the configuration change of a circuit subsequent the circuit C.

With this structure, the computation processing unit 101 is able to use, in the circuit B, the computation result obtained by the circuit A, and similarly, use, in the circuit C, the computation result obtained by the circuit B.

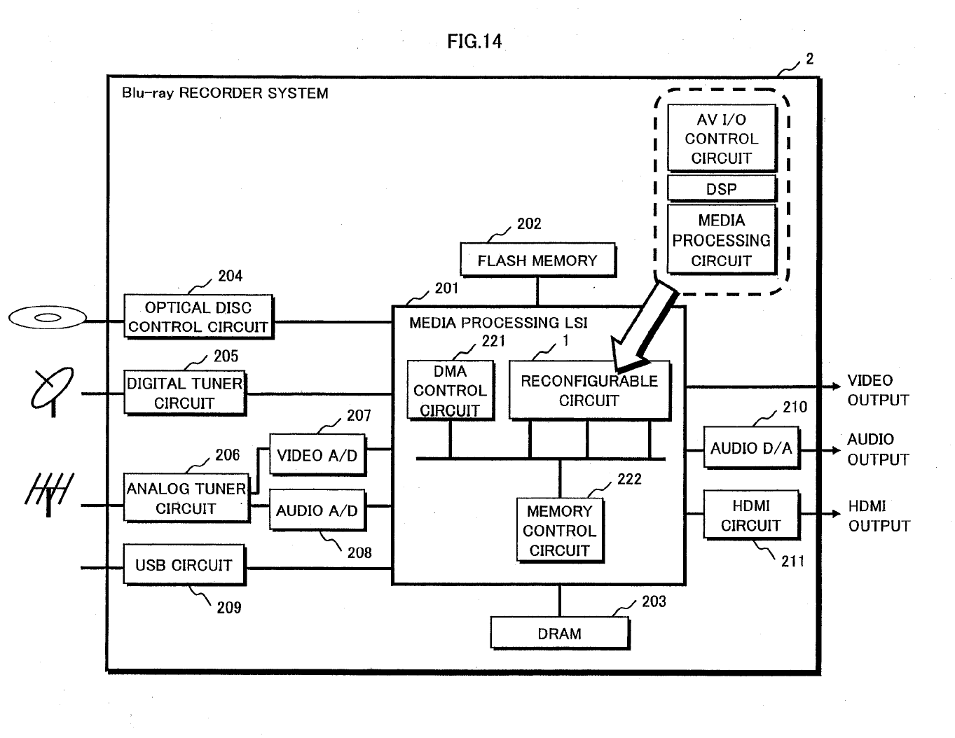

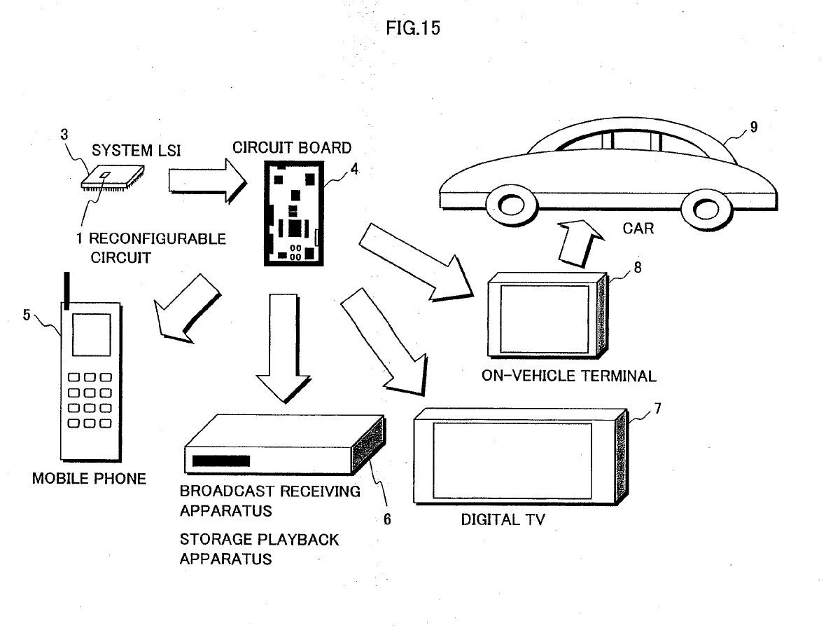

(4) The reconfigurable circuit 1 described in the embodiment above can be applied, for example, to a Blu-ray recorder system 2 shown in FIG. 14.

As shown in FIG. 14, the Blu-ray recorder system 2 includes a memory processing LSI 201, a flash memory 202, a DRAM 203, an optical disc control circuit 204, a digital tuner circuit 205, an analog tuner circuit 206, a video A/D 207, an audio A/D 208, a USB circuit 209, an audio D/A 210, and an HDMI circuit 211.

Here, the media processing LSI 201 includes the reconfigurable circuit 1 described in the embodiment above, a DMA control circuit 211, and a media control circuit 222.

The reconfigurable cell 1 realizes functions such as an AV I/O control circuit, DSP (Digital Signal Processor), and a media processing circuit while changing the configuration of each reconfiguration cell.

(5) Furthermore, the reconfigurable circuit 1 can be mounted and used in various electronic devices.

For example, as shown in FIG. 15, a system LSI 3 having the reconfigurable circuit 1 incorporated therein is mounted on a circuit board 4. Then, the circuit board 4 can be applied to a mobile telephone, a broadcasting reception apparatus or a storage/playback apparatus 6, a digital TV7, an on-vehicle terminal 8, and the like. The on-vehicle terminal 8 can be installed and used in a car 9.

(6) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the digital signal recorded in any of the aforementioned recording medium apparatuses.

Furthermore, the present invention may be the computer program or the digital signal transmitted on an electric communication network, a wireless or wired communication network, or a network of which the Internet is representative.

Also, the present invention may be a computer system including a microprocessor and a memory, whereby the memory stores the computer program, and the microprocessor operates in accordance with the computer program.

Furthermore, by transferring the program or the digital signal to the recording medium, or by transferring the program or the digital signal via a network or the like, the program or the digital signal may be executed by another independent computer system.

(7) The present invention may be any combination of the above-described embodiments and modifications.

### INDUSTRIAL APPLICABILITY

The present invention is applicable to reconfigurable circuits such as FPGAs, PLDs, and reconfigurable logic, and particularly effective for multi-context type reconfigurable logic which repeatedly perform reconfiguration every several clocks. The present invention may be utilized by the manufacture and sales industry of reconfigurable circuits and manufacture and sales industry of electronic devices having such reconfigurable circuits incorporated therein.

1. A reconfigurable circuit that comprises a plurality of reconfiguration cells and changes a configuration of a computation processing unit included in each of the reconfiguration cells, wherein
the each of the reconfiguration cells further includes:
a computation storage unit operable to store a result of a computation performed by the computation processing unit;
a flag holding unit operable to hold an initialization flag indicating whether an initialization of the computation storage unit is required; and
an initialization control unit operable to, during the configuration change of the computation processing unit, control the initialization of the computation storage unit based on the initialization flag held by the flag holding unit.

2. The reconfigurable circuit of claim 1, wherein
the initialization control unit performs the initialization control such that (i) if the initialization flag indicates that the initialization is required, the computation storage unit is initialized, and (ii) if the initialization flag indicates that the initialization is not required, the computation storage unit is not initialized.

3. The reconfigurable circuit of claim 2, wherein
the each of the reconfiguration cells further includes:
an acquisition unit operable to acquire (a) a piece of configuration information to be used for the configuration change of the computation processing unit and (b) the initialization flag in correspondence with each other; and
a configuration information holding unit operable to hold the piece of configuration information acquired by the acquisition unit,
the flag holding unit holds the initialization flag acquired by the acquisition unit, and
the initialization control unit performs the initialization control on the computation storage unit based on the initialization flag during the configuration change of the computation processing unit performed in accordance with the piece of configuration information corresponding to the initialization flag.

4. The reconfigurable circuit of claim 3, wherein
the acquisition unit, after acquiring the piece of configuration information and the initialization flag, acquires an other piece of configuration information to be used for a further configuration change of the computation processing unit, and
the initialization control unit performs the initialization control on the computation storage unit based on the initialization flag during the configuration change of the computation processing unit performed in accordance with the other piece of configuration information acquired by the acquisition unit.

5. The reconfigurable circuit of claim 4, wherein
the each of the reconfiguration cells is in a mode that is one of a protection mode and a normal mode, the protection mode protecting the computation storage unit from being initialized, and the normal mode allowing the computation storage unit to be initialized,
the initialization flag includes (i) a protection setting flag for shifting the mode of the reconfiguration cell from the normal mode to the protection mode and (ii) a protection cancellation flag for shifting the mode of the reconfiguration cell from the protection mode to the normal mode,
the initialization control unit performs the initialization control such that (i) one of (a) if the reconfiguration cell is in the normal mode and (b) if the reconfiguration cell is in the protection mode and the initialization flag is set to the protection cancellation flag, the computation storage unit is initialized during the configuration change of the computation processing unit performed in accordance with the piece of configuration information, and (ii) if the reconfiguration cell is in the protection mode and the initialization flag is not set to the protection cancellation flag, the computation storage unit is not initialized during the configuration change of the computation processing unit performed in accordance with the piece of configuration information.

6. The reconfigurable circuit of claim 3, wherein
the configuration information holding unit outputs the piece of configuration information to the computation processing unit upon detecting a configuration change signal which is an instruction to perform the configuration change of the computation processing unit,
the computation processing unit performs an internal reconfiguration using the piece of configuration information received from the configuration information holding unit, and
the initialization control unit, upon detecting the configuration change signal, performs the initialization control on the computation storage unit in parallel with the internal reconfiguration performed by the computation processing unit.

7. The reconfigurable circuit of claim 6, wherein
the initialization control unit includes:
an initialization generation unit operable to generate an initialization signal upon detecting the configuration change signal; and
an initialization protection unit operable to, upon receiving the initialization signal generated by the initialization generation unit, judge, based on the initialization flag held by the flag holding unit, whether or not to output the initialization signal to the computation storage unit, and (i) only when the judgement is affirmative, output the initialization signal to the computation storage unit, and (ii) when the judgement is negative, not output the initialization signal to the computation storage unit, and
the computation storage unit performs an internal initialization only upon receiving the initialization signal from the initialization protection unit.

8. A configuration information generation apparatus for generating configuration information used by a reconfigurable circuit that includes a plurality of reconfiguration cells and changes a configuration of a computation processing unit included in each of the reconfiguration cells further including a computation storage unit operable to store a result of a computation performed by the computation processing unit, the configuration information generation apparatus receiving from a user, in a process of generating the configuration information, a selection of whether or not the computation storage unit is to be initialized during the configuration change of the reconfiguration cell.

9. The configuration information generation apparatus of claim 8, comprising:
a source code input unit operable to receive input of a source code computation configuration information which is information to be used for the configuration change of the computation processing unit;
an analysis unit operable to analyze a syntax of the source code;
an output unit operable to output, when the analysis unit detects a predetermined syntax indicating the computation storage unit, a GUI image for receiving, from a user, setting of an initialization flag which indicates whether the computation storage unit is to be initialized or not during the configuration change; and
a user input unit operable to receive the setting of the initialization flag by a user operation.

10. The configuration information generation apparatus of claim 9, further comprising
a configuration information generation unit operable to generate the configuration information including the computation configuration information and the initialization flag set by the user.

11. An initialization method used by a reconfigurable circuit that includes a plurality of reconfiguration cells and changes a configuration of a computation processing unit included in each of the reconfiguration cells, wherein
the each of the reconfiguration cells further includes:
a computation storage unit operable to store a result of a computation performed by the computation processing unit; and
a flag holding unit operable to hold an initialization flag indicating whether an initialization of the computation storage unit is required,
the initialization method comprising:
an acquiring step of acquiring an initialization flag from the flag holding unit;
a judging step of judging a value of the initialization flag; and
a controlling step of controlling an initialization of the computation storage unit in accordance with the value of the initialization flag during the configuration change of the computation processing unit.
